(19) United States
(12) Patent Application Publication
(10) Pub. No.: US 2014/0082104 A1
(43) Pub. Date: Mar. 20, 2014

(54) Updating a Message

(71) Applicant: James M. Mann, Cypress, TX (US)

(72) Inventor: James M. Mann, Cypress, TX (US)

(21) Appl. No.: 14/006,201

(22) PCT Filed: May 27, 2011
(86) PCT No.: PCT/US11/38392

§ 371 Date: Sep. 19, 2013

Related U.S. Application Data
(60) Provisional application No. 61/491,014, filed on May 27, 2011.

(51) Int. Cl. H04L 12/58

(52) U.S. Cl. CPC H04L 51/046
USPC 709/206

(57) ABSTRACT

Implementations disclosed herein relate to updating a message. In one embodiment, a processor 302 receives a message from an electronic device 305 via a network 304 and contracts the received message. The processor 302 may then send the contracted message to the electronic device 305 via the network 304. In one embodiment, a processor 102 receives a message from an electronic device 105 via a network 104 and expands the received message. The processor 192 may then send the expanded message to the electronic device 105 via the network 104.

### BACKGROUND

Abbreviations are common for electronic messages, such as Short Message Service messages due to the difficulty of typing on increasingly smaller keyboards and the character limits of some messaging services. The abbreviations may be human readable. However, in some cases, the abbreviations may be difficult for users to remember or to read.

### BRIEF DESCRIPTION OF THE DRAWINGS

The drawings describe example implementations. The drawings show methods performed in an example order, but the methods may also be performed in other orders. The following detailed description references the drawings, wherein:

FIG. 1 is a block diagram illustrating one example of a computing system.

FIG. 2 is a flow chart illustrating one example of a method to lengthen a message.

FIG. 3 is a block diagram illustrating one example of a computing system.

FIG. 4 is a flow chart illustrating one example of a method to shorten a message.

FIG. 5 is a block diagram illustrating one example of a computing system.

FIG. 6 is a flow chart illustrating one example of communicating with expanded and contracted messages.

FIG. 7 is a diagram illustrating one example of contracting a message based on a dictionary associated with an identifier.

### DETAILED DESCRIPTION

Electronic messages often contain abbreviations that may be difficult to remember or to interpret. To address this problem, a cloud service may provide the ability to expand or contract a message. For example, a message may be sent via a network from a user electronic device to a server that contracts or expands a message based on a stored dictionary and then transmits the contracted or expanded message back to the user electronic device. The received message may then be read or transmitted from the user electronic device. The message may be contracted or expanded, for example, based on a stored look up conversion table.

Contracting a message may be advantageous, for example, where a message service limits the amount of available characters. Expanding a message may be useful where a user is unable to read a contracted message. In some cases, expanding a message may be done prior to analyzing a message with other software, such as text to speech systems. A message may be contracted by a sending party and expanded by a recipient. In some cases, contraction or expansion may be used by one party to a communication, such as where a sending user abbreviates the message on his own and a recipient uses the expansion service to expand it before reading.

Providing a message conversion service remote from the user electronic device allows the user electronic device to have less storage space for storing software for performing the conversion and for storing the abbreviation look up table. The server may update the dictionary of abbreviations without knowledge of the user electronic device, and the same updated dictionary may be available to a second electronic device interpreting a message composed by accessing the updated dictionary from the first electronic device.

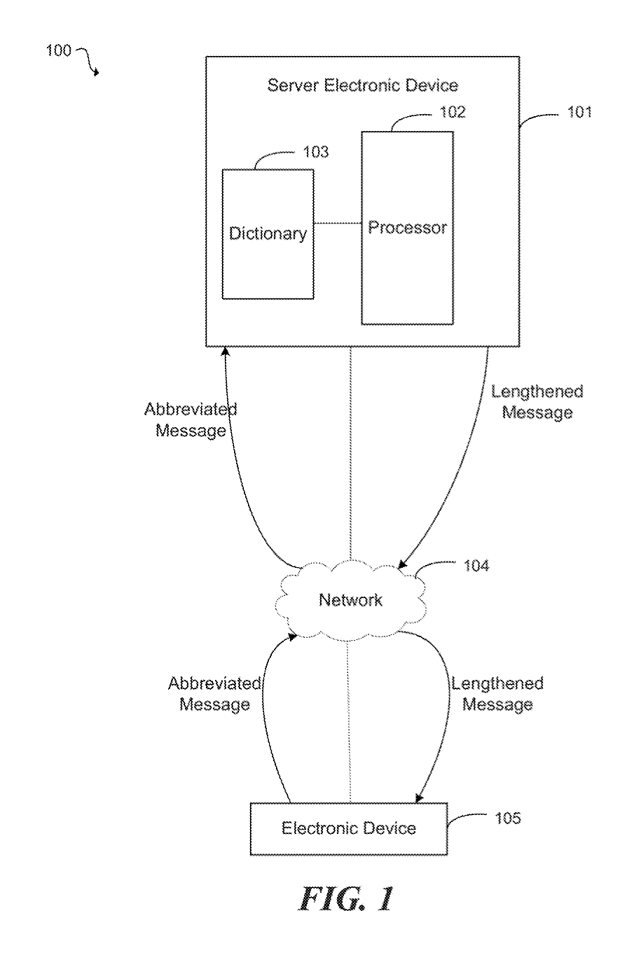

FIG. 1 is a block diagram illustrating one example of a computing system 100. The computing system 100 may include a server electronic device 101, a network 104, and an electronic device 105. The server electronic device 101 includes a processor 102 and a dictionary 103. The processor 102 may be any suitable processor, such as a central processing unit (CPU), a semiconductor-based microprocessor, or any other device suitable for retrieval and execution of instructions. In one implementation, the server electronic device 101 includes logic instead of or in addition to the processor 102. As an alternative or in addition to fetching, decoding, and executing instructions, the processor 102 may include one or more integrated circuits (ICs) (e.g., an application specific integrated circuit (ASIC)) or other electronic circuits that comprise a plurality of electronic components for performing the functionality described below. In one implementation, the server electronic device 101 includes multiple processors. For example, one processor may perform some functionality and another processor may perform other functionality described below.

The network 104 may be any suitable network, such as the Internet. The processor 102 may receive information from the electronic device 105 via the network 104 and may send information to the electronic device 105 via the network. In one implementation, the processor 102 also communicates with other electronic devices via the network 104.

The electronic device 105 may be any suitable electronic device. For example, the electronic device 105 may be a personal electronic device, such as a desktop, laptop, or mobile computing device. The electronic device 105 may be a mobile phone. In one implementation, a message may be created on the electronic device 105 and sent to the server electronic device 101 via the network 104. In one implementation, the electronic device 105 may send a message to the server electronic device 101 for the server electronic device 101 to lengthen. For example, a user may determine that a message is difficult to read and send the message to the server electronic device 101 for conversion into a longer form more readable format. The electronic device 105 may connect to the server electronic device 101 in any suitable manner. For example, the electronic device 105 may upload a document to the server electronic device 101 through a web user interface or through an application downloaded onto the electronic device 105, such as a mobile device application, for communicating with the server electronic device 101.

The server electronic device 101 may receive the message from the network 104 and lengthen the message based on a comparison of the message to the dictionary 103. The dictionary 103 may include a look up table of expanded words or phrases correlated with abbreviations. The abbreviations in the received message may be compared to the abbreviations in the dictionary 103, and the abbreviations may be replaced with the expanded words or phrases from the dictionary 103. The server electronic device 101 may then send the lengthened message back to the electronic device 105 that originally sent the message.

In one implementation, the server electronic device 101 includes a machine-readable storage medium. The machine-readable storage medium may be any suitable machine readable medium, such as an electronic, magnetic, optical, or other physical storage device that stores executable instructions or other data (e.g., a hard disk drive, random access memory, flash memory, etc.). The machine-readable storage medium may be, for example, a computer readable non-transitory medium. The machine-readable storage medium may include instructions executable by the processor 102 to lengthen the received message and transmit it back to the electronic device 105. In one implementation, the processor 102 may perform the message lengthening service for multiple electronic devices.

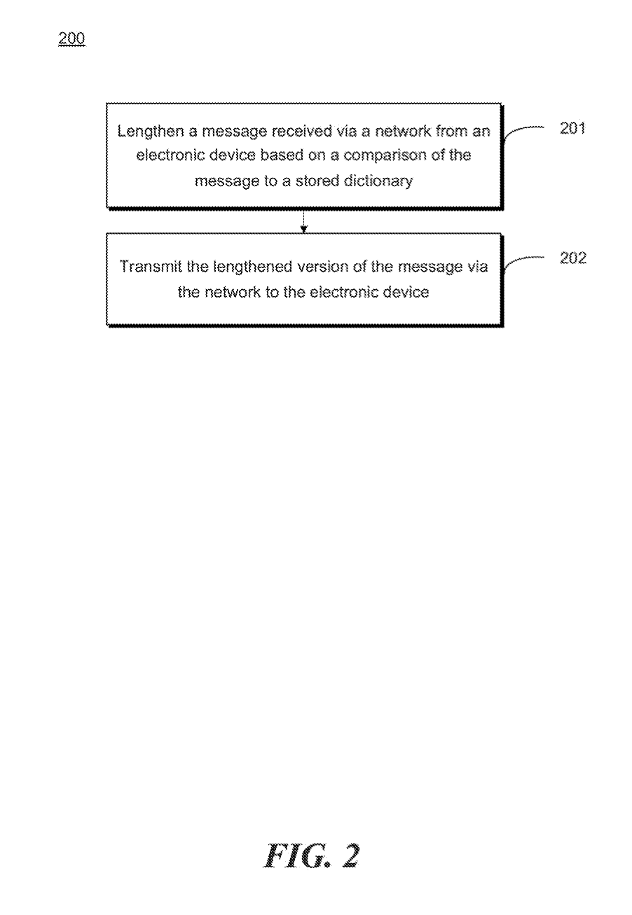

FIG. 2 is a flow chart 200 illustrating one example of a method to lengthen a message. A server electronic device may receive a message from a user electronic device via a network and lengthen the message based on a stored dictionary. For example, the server electronic device may look up words, phrases, or abbreviations in the message and compare them to entries in the dictionary. Entries that correlate to text in the message may be inserted into the message to replace abbreviations or shortened phrases in the message. The server electronic device may then transmit the lengthened message back to the user electronic device. This may allow a user to lengthen a message without storing a dictionary or conversion software on the user's electronic device. A user may type a message in an abbreviated format on a small electronic device, such as a mobile phone, and the user may expand the message before transmitting, or the recipient may chose to expand the message before reading it. The method may be implemented, for example, by the server electronic device 101 from FIG. 1.

Beginning at 201, a processor lengthens a message received via a network from an electronic device based on a comparison of the message to a stored dictionary. For example, the processor may receive a message via the Internet from a user electronic device, such as from a personal computer or mobile computing device. The user device may send the message to the processor in response to user input to lengthen the message, for example, because of a user having trouble understanding the message, or in response to an automated process. For example, each Short Service Message or each Short Service Message from a particular recipient may be automatically sent to the processor for lengthening, or a user may select to send a particular message to the processor for lengthening.

The dictionary may store a list of shorter words, abbreviations, and phrases correlating with longer forms. The stored dictionary may be stored in the same electronic device as the processor, or the processor may access the dictionary via a network in one implementation there are multiple dictionaries. The processor may determine which dictionary to use for a message based on a dictionary identifier received with the message. In some cases, the processor may receive information about a recipient or sender of the message and look up the dictionary associated with the recipient or sender in a storage. The processor may use the associated dictionary for lengthening the message. In some examples, the processor may receive information about a degree of lengthening the message, such as a character limit for a lengthened message.

The processor may compare the words or phrases in the message to entries in the dictionary, if a word or phrase, such as an abbreviation, in the message matches or otherwise correlates with a dictionary entry short form, the processor may replace the word or phrase in the message with the associated long form in the dictionary.

Continuing to 202, the processor transmits the lengthened version of the message via the network to the electronic device. For example, the processor may send the lengthened version of the message back to the electronic device via the Internet. The user of the electronic device may then choose to send the message to a recipient. In some cases, the message may be a message received at the user electronic device, and the user may read the message after receiving the lengthened version. In some cases, software may analyze the lengthened message, such as software for text to speech conversion or software for text analysis.

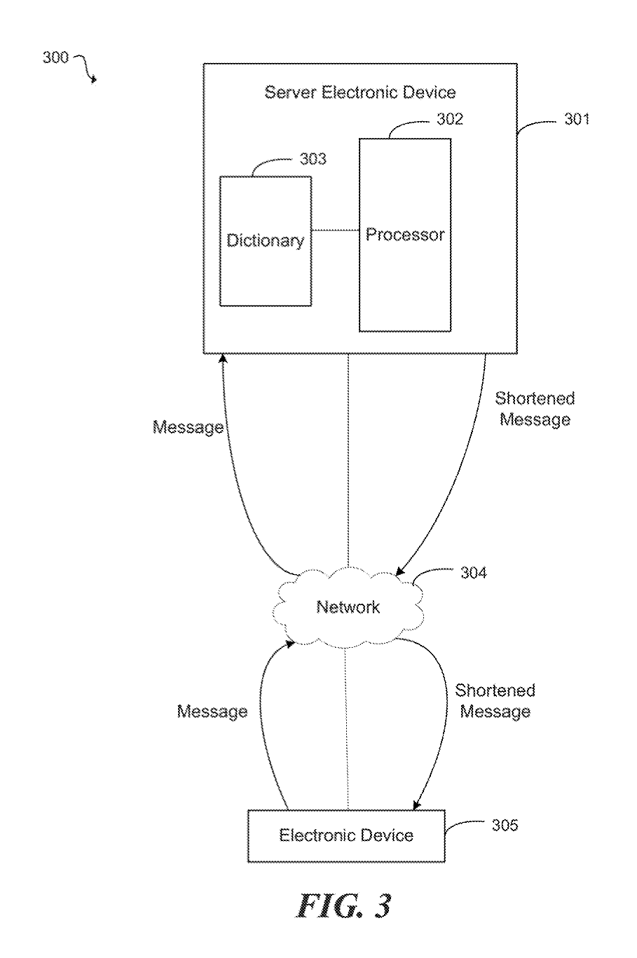

FIG. 3 is a block diagram illustrating one example of a computing system 300. The computing system 300 may include a server electronic device 301, a network 304, and an electronic device 305. The server electronic device 301 includes a processor 302 and a dictionary 303. The processor 302 may be any suitable processor, such as a central processing unit (CPU), a semiconductor-based microprocessor, or any other device suitable for retrieval and execution of instructions. In one implementation, the server electronic device 301 includes logic instead of or in addition to the processor 302. As an alternative or in addition to fetching, decoding, and executing instructions, the processor 302 may include one or more integrated circuits (ICs) (e.g., an application specific integrated circuit (ASIC)) or other electronic circuits that comprise a plurality of electronic components for performing the functionality described below. In one implementation, the server electronic device 301 includes multiple processors. For example, one processor may perform some functionality and another processor may perform other functionality described below.

The processor 302 may communicate with the electronic device 305 via the network 304. The network 304 may be, for example, the Internet. The electronic device 305 may be, for example, a personal computer or mobile computing device. In some cases, the processor 302 may provide a message contracting service for multiple electronic devices communicating with the processor 302 via the network 304.

A user may create a message on the electronic device 305, such as an instant message, social networking message, or Short Message Service message. In some cases, a user may want the message to be shortened such that words or phrases are abbreviated. For example, the messaging service being used may have a character limit. The electronic device 305 may transmit the created message to the server electronic device 301 via the network 304. The electronic device 305 may upload a document to the server electronic device 301 through a web user interface or through an application downloaded onto the electronic device 305. For example, a mobile computing device may include a web application for communicating with the server electronic device 301.

The server electronic device 301 receives the message from the electronic device 305. The processor 302 may shorten the receive message using the dictionary 303. The dictionary 303 may include a table of words or phrases correlated with shortened forms. In some implementations, the same dictionary may be used for shortening messages as for lengthening messages. The processor 302 may analyze the message and locate words or phrases in the dictionary 303. The messages words or phrases that are found in the dictionary may be replaced with the shortened forms found in the dictionary 303. The dictionary 303 may include human readable shortened forms. The server electronic device 301 may then transmit the message back to the electronic device 305. The user of the electronic device 305 may decide to send the message to another user electronic device. In some cases, the recipient may then use a service, such as the one provide by the server electronic device 101, to expand the received message to make it more readable.

In one example, the server electronic device 301 includes a machine-readable storage medium. The machine-readable storage medium may be any suitable machine readable medium, such as an electronic, magnetic, optical, or other physical storage device that stores executable instructions or other data (e.g., a hard disk drive, random access memory, flash memory, etc.). The machine-readable storage medium may be, for example, a computer readable non-transitory medium. The machine-readable storage medium may include instructions executable by the processor 302 to shorten the received message and transmit it back to the electronic device 305. In one implementation, the processor 302 may perform the message lengthening service for multiple electronic devices.

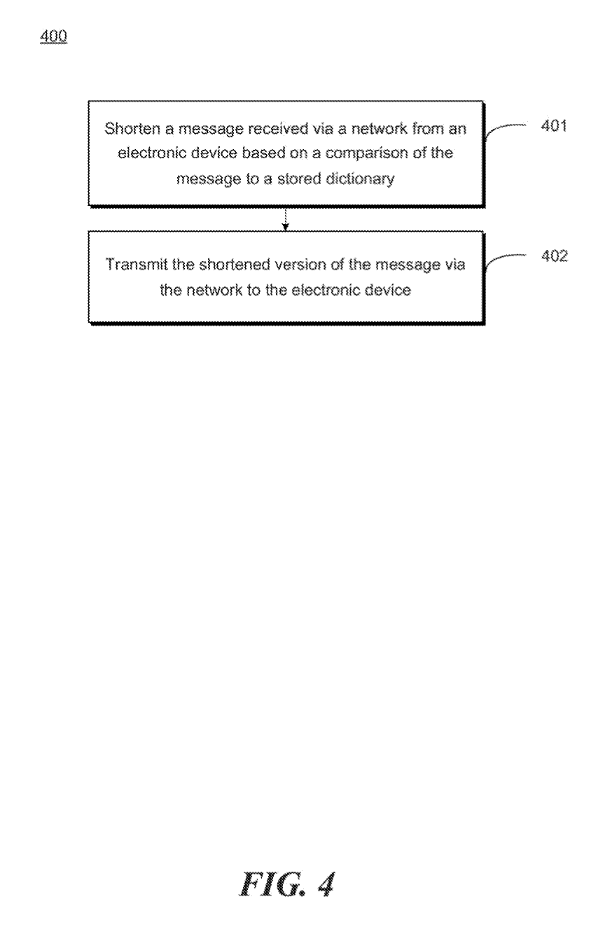

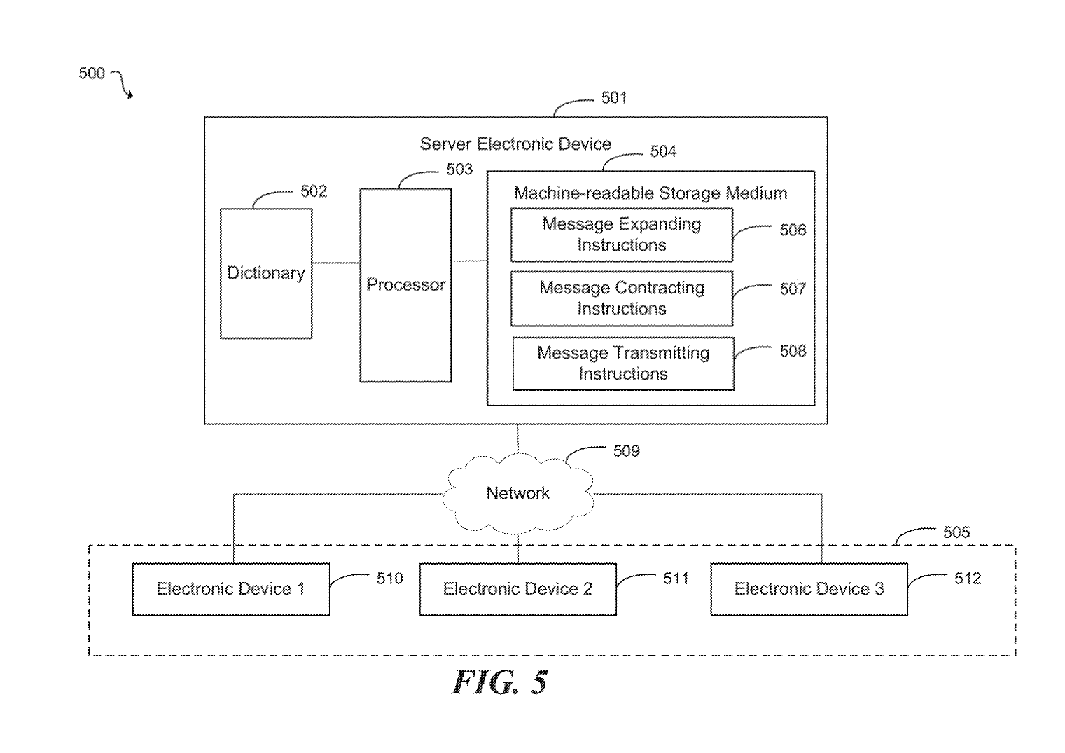

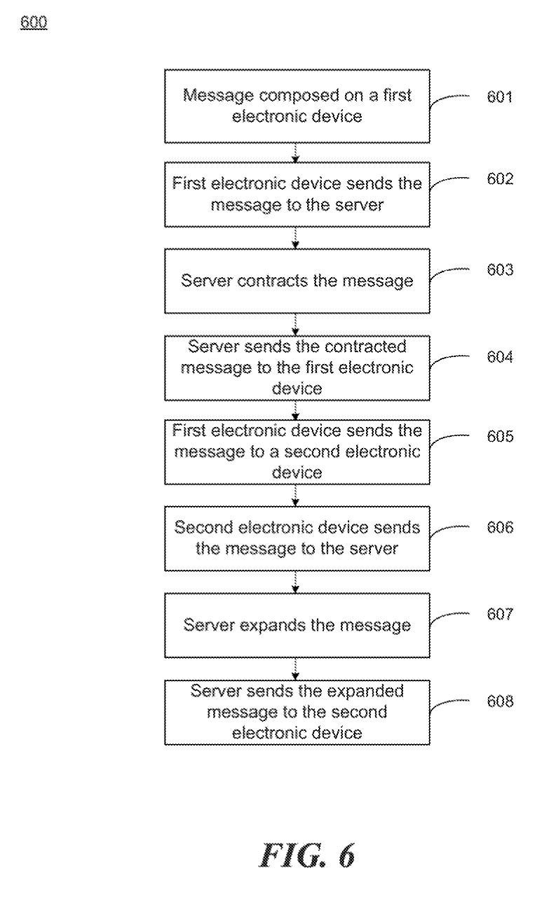

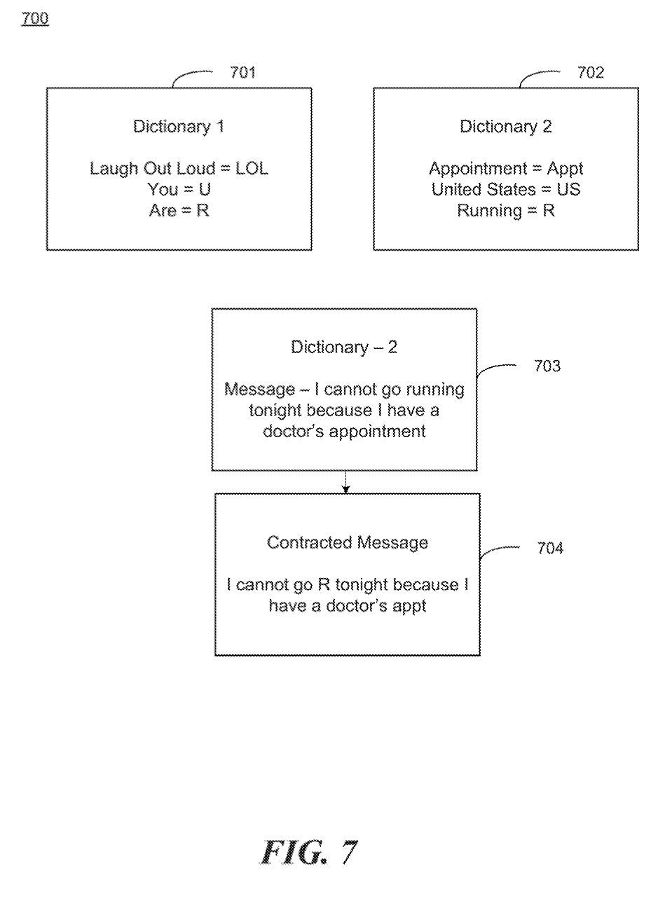

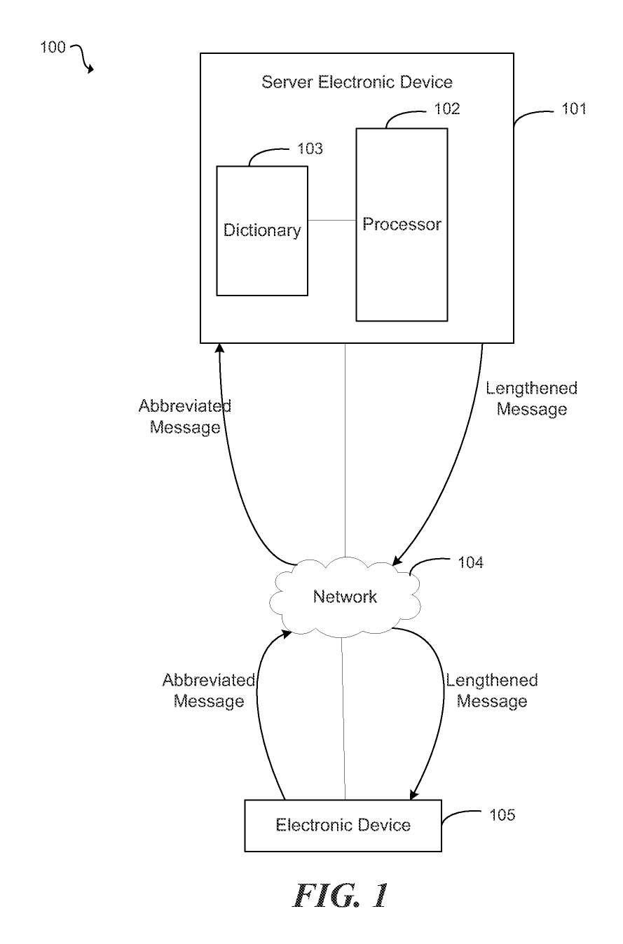

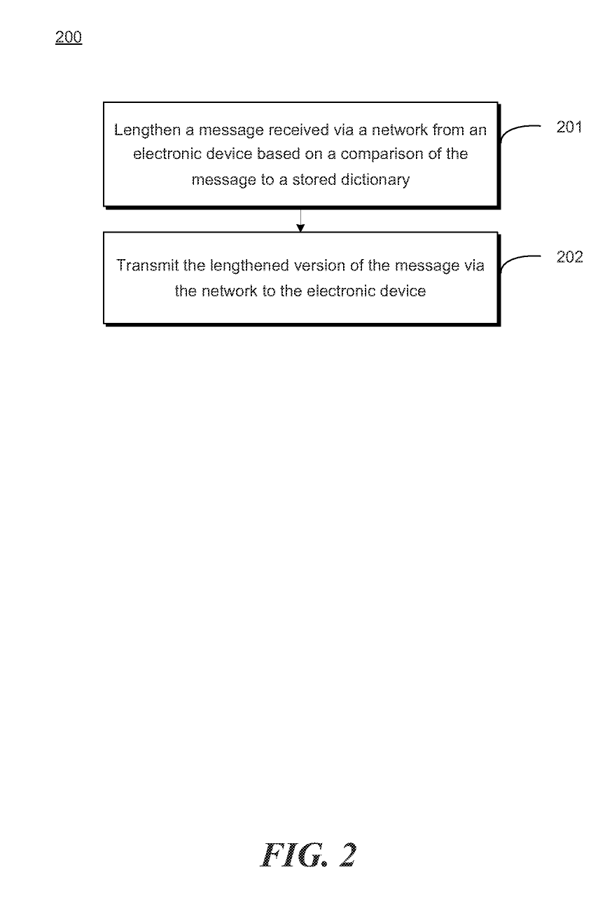

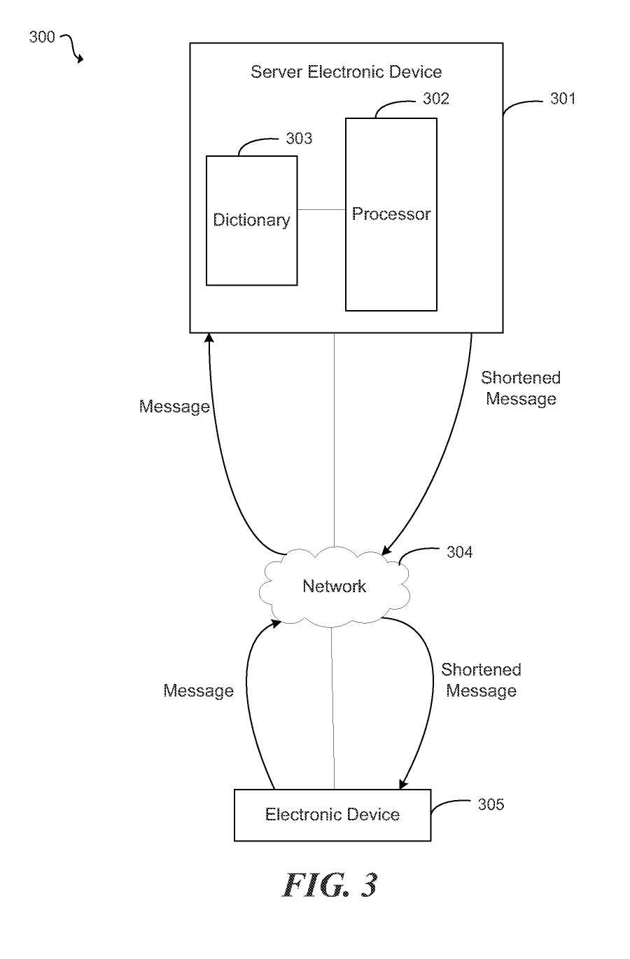

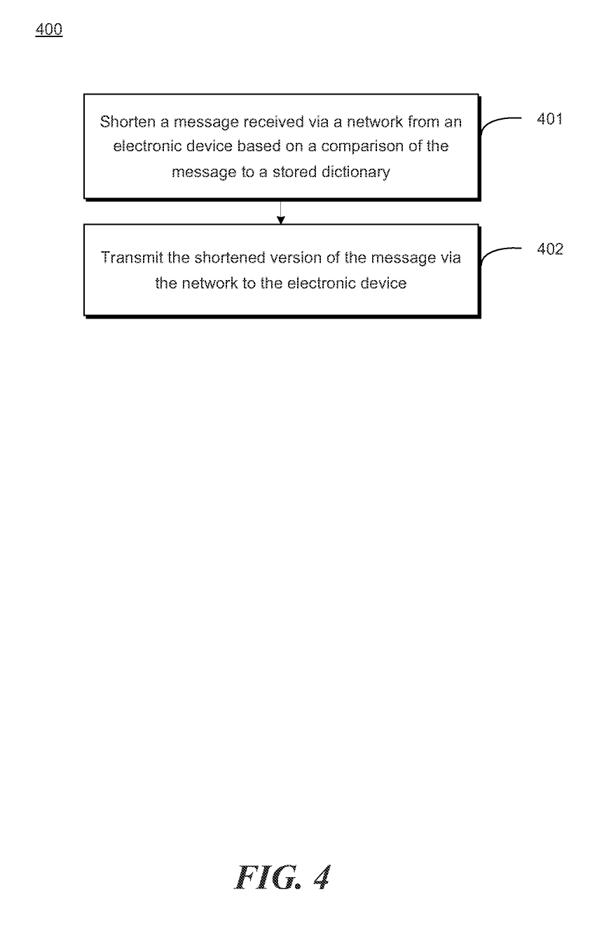

FIG. 4 is a flow chart 400 illustrating one example of a method to shorten a message. A message may be sent from an electronic device to a server that provides a message shortening service. For example, a user may want to shorten a message so that if fits within a character limit of a messaging service. The server may provide the service to electronic devices that communicate with the server via the Internet. The server may shorten the message by comparing the message to a dictionary that includes words or phrases and corresponding abbreviations. The server may then return the shortened message to the electronic device that sent the message to the server for shortening. The method may be implemented, for example, by the server electronic device 301 of FIG. 3.

Beginning at 401, a processor shortens a message received via a network from an electronic device based on a comparison of the message to a stored dictionary. For example, the processor may receive a message from the Internet. The processor may compare the words or phrases in the message to a dictionary that correlates words and phrases to abbreviations. The abbreviations may be human readable abbreviations, such as abbreviations commonly used in messages. The process may replace words or phrases in the message with the correlating abbreviations found in the dictionary.

In one implementation, the processor receives information about a character limit or a degree of shortening the message. For example, a messaging type, such as a type of social networking message, instant message, or a Short Message Service message, may have a character limit, and the processor may shorten the message by replacing words or phrases until the character limit is reached. The processor may shorten the words or phrases in any order, such as based on the order in the message. In some cases, the dictionary may have a level of shortening associated with each shortened form such that more common abbreviations are used to replace the message before less common abbreviations until the character limit is reached. In some cases, a user may request a level of shortening without a particular character limit.

In one implementation, the process may access multiple dictionaries. The processor may receive an identifier associated with the desired dictionary for shortening the message, or the processor may determine the appropriate dictionary. In some cases, a dictionary may be tailored to a particular user or type of user.

Proceeding to 402, the processor transmits the shortened version of the message via the network to the electronic device. For example, the processor may transmit the shortened version via the Internet back to the electronic device that sent the message to the processor for contracting. In some cases, the user may then choose to send the shortened message to a recipient.

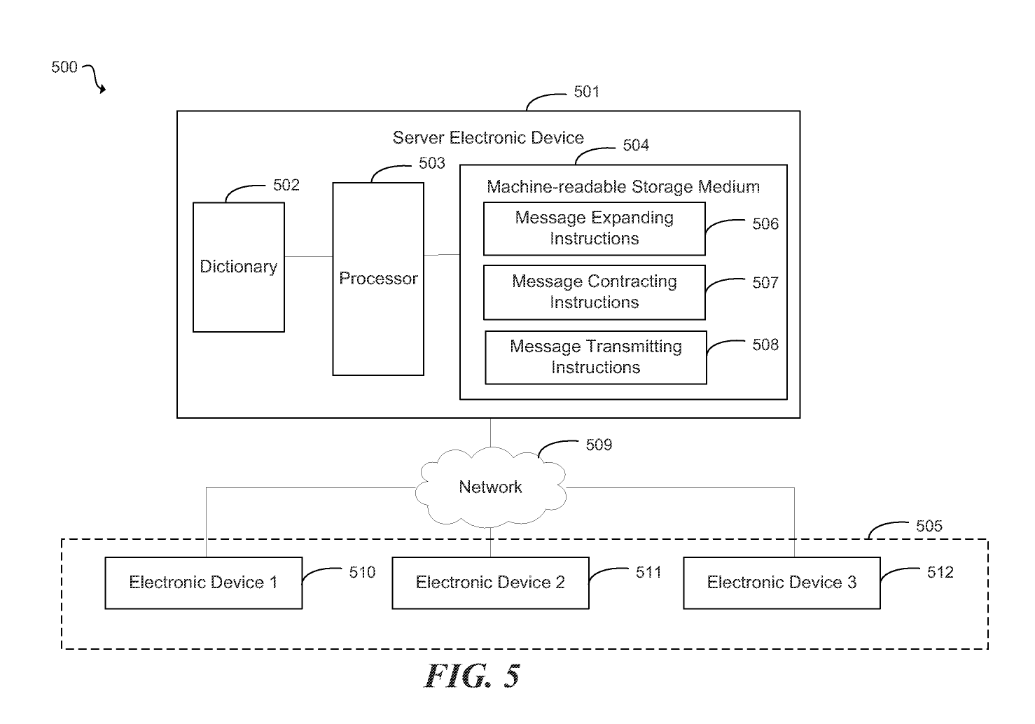

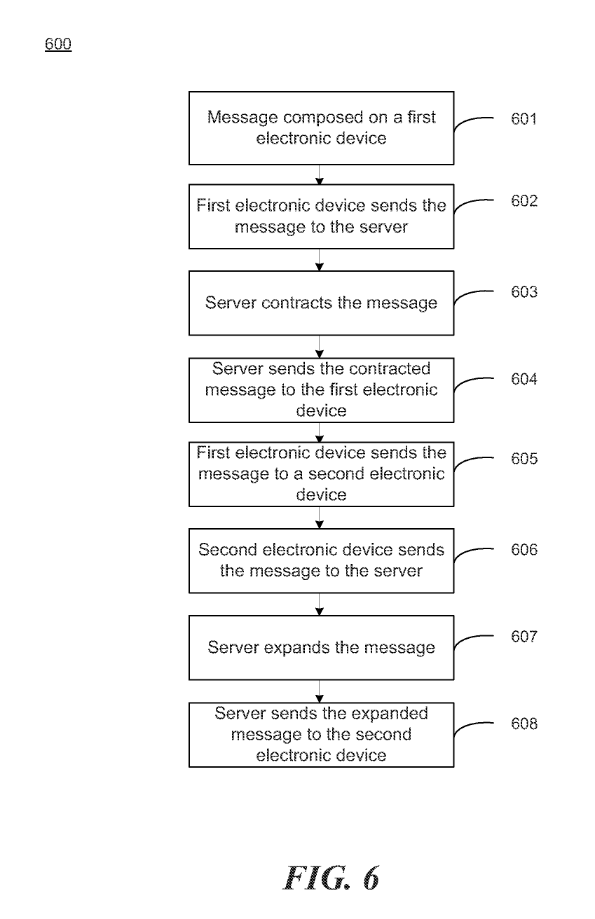

FIG. 5 is a block diagram illustrating one example of a computing system 500. The computing system 500 includes, for example, a server electronic device 501, a network 500, and electronic devices 505 including a first electronic device 510, a second electronic device 511, and a third electronic device 512. The electronic devices 505 may include more or fewer electronic devices. The server electronic device 501 may provide a service for expanding and contracting messages received from: the electronic devices 505. For example, an electronic device may send the server electronic device 501 a message to expand or contract. The server electronic device may expand or contract the message and return the updated message to the electronic device via the network 509. The network 509 may be, for example, the Internet.

The server electronic device 501 may be any suitable type of electronic device. The server electronic device 501 may include a processor 503, a dictionary 502, and a machine-readable storage medium 504. The dictionary 502 may include a lookup table of words and phrases with longer forms associated with shorter forms. The shorter forms of words and phrases may in some cases include human readable abbreviations. The processor 503 may be any suitable processor, such as a central processing unit (CPU), a semiconductor-based microprocessor, or any other device suitable for retrieval and execution of instructions. In one implementation, the electronic device 101 includes logic instead of or in addition to the processor 503. As an alternative or in addition to fetching, decoding, and executing instructions, the processor 503 may include one or more integrated circuits (ICs) (e.g., an application specific integrated circuit (ASIC)) or other electronic circuits that comprise a plurality of electronic components for performing the functionality described below. In one implementation, the server electronic device 501 includes multiple processors. For example, one processor may perform some functionality and another processor may perform other functionality described below.

The machine-readable storage medium 504 may be any suitable machine readable medium, such as an electronic, magnetic, optical, or other physical storage device that stores executable instructions or ether data (e.g., a hard disk drive, random access memory, flash memory, etc.). The machine-readable storage medium 504 may be, for example, a computer readable non-transitory medium. The machine-readable storage medium 504 may include instructions executable by the processor 503.

The machine-readable storage medium 504 may include message expanding instructions 506, message contracting instructions 507, and message transmitting instructions 508. The message expanding instructions 508 may include instructions for expanding a message by comparing a received message to the dictionary 502. The message expanding instructions 506 may be executed where the processor 503 determines that the received message should be expanded, such as based on information received with the message. The message contracting instructions 507 may be executed where the processor 503 determines that the received message should be contracted. For example, a user may subscribe to both a message expansion and contraction service. In some cases, one user may subscribe to the message expansion service and another user may subscribe to the message contraction service. The message may be receive via the network 509.

The message expanding instructions 506 may include instructions to compare the message to the dictionary 502 such that abbreviations are looked up in the dictionary 502 and replaced with the longer forms. The message contracting instructions 507 may include instructions for contracting a message by comparing a message received via the network 510 to the dictionary 502 to replace Sanger forms of words or phrases with shorter forms from the dictionary 502. The message transmitting instructions 508 may include instructions for transmitting the contracted or expanded message back to the electronic device of the electronic devices 505 that sent the message to the server electronic device 501.

FIG. 8 is a flow chart 800 illustrating one example of communicating with expanded and contracted messages. For example, one electronic device may contract a message before sending, such as to fit within a particular character limit, and a recipient electronic device may then expand the contracted message to make it more readable. At 601, a user composes a message on a first electronic device. For example, a user may compose a Short Message Service message on a mobile phone. At 602, the first electronic device sends the message to the server. For example, the user may want the message contracted to fit within a particular character limit. At 603, the server contracts the received message. The server may compare the message to a stored lookup table to contract the message. At 604, the server sends the contracted message back to the first electronic device.

At 605, the first electronic device sends the contracted message to a second electronic device. For example, a user of the first electronic device may compose the message to be sent to the user of the second electronic device. At 606, the second electronic device sends the received message to the server to be expanded. For example, the user of the second electronic device may be unable to read the contracted message. At 607, the server expands the message received from the second electronic device. The server may compare the message to a table to determine how to replace abbreviations in the message with correlating expanded forms. At 608, the server sends the expanded message back to the second electronic device. The user of the second electronic device may then read the message. In some cases, the second electronic device may have software analyze the expanded message, such as to translate it into a voice message.

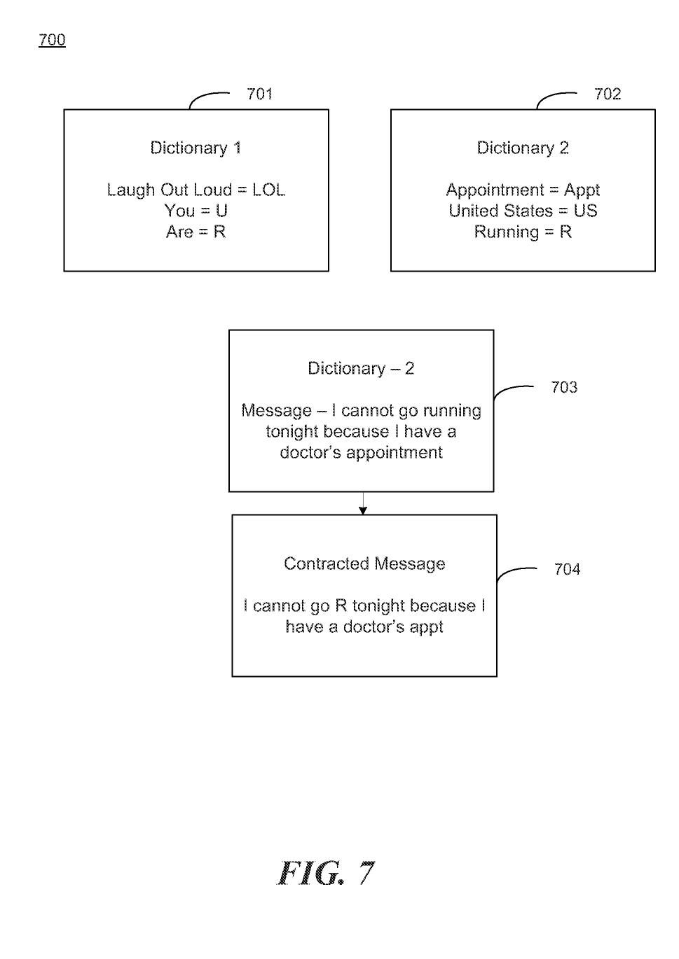

FIG. 7 is a diagram illustrating one example 700 of contracting a message based on a dictionary associated with an identifier. For example, in some cases an electronic device may store or have access to multiple sets of dictionaries. The dictionaries may be different languages, styles, or types of abbreviations. The server may locate the specified dictionary based on the identifier. In some cases, other information is provided, and the processor determines the appropriate dictionary. For example, information about user dictionary preferences may be stored and accessed. A dictionary may be specific to users or message recipients, based on a level of a user's ability to understand abbreviations, or based on other characteristics of a user, such as age or location.

A dictionary for expanding or contracting a message may be created in any suitable manner. For example, the dictionary may be manually created by a user adding entries. In one implementation the dictionary is created based on learning techniques. For example, the server may request user feedback on a dictionary expansion or contraction, and update the dictionary based on the feedback.

The example 700 includes a first dictionary 701 and a second dictionary 702. The first dictionary 701 and the second dictionary 702 each include a set of expanded words or phrases correlated to an abbreviation. In some cases, the abbreviations stand for different words or phrases, such as where R may mean “are” in the first dictionary 701 and “running” in the second dictionary 702. Message 703 includes message text and a dictionary identifier indicating that the message should be contracted with the second dictionary 702. Contracted message 704 shows the message contracted using the second dictionary 702.

A network based service for expanding or contracting a message may allow a user to automatically adjust a message, such as prior to transmitting or reading the message. The network based service may allow the same dictionary to be available to multiple parties to a communication. It may also allow for greater functionality without consuming additional storage space on a user's electronic device.

1. A method, comprising:
updating, by a processor 102, a message received via a network from an electronic device to lengthen the based on a comparison of the message to a stored dictionary; and
transmitting, by a processor 102, the lengthened version of the message via the network to the electronic device.

2. The method of claim 1, wherein the message comprises at least one of: a Short Message Service, email, social networking, or instant message.

3. The method of claim 1, further comprising:
receiving a second message via a network from a second electronic device;
contracting the second message based on a comparison of the second message to the stored dictionary; and
transmitting the contracted version of the second message via the network to the second electronic device.

4. The method of claim 1, further comprising:
sending, by the electronic device, the message to the processor for lengthening; and
receiving, by the electronic device, the lengthened version of the message from the processor via the network.

5. The method of claim 1, further comprising:
receiving an identifier associated with a dictionary; and
comparing the message to a stored dictionary associated with the identifier.

6. An apparatus, comprising;
a processor 302 to:
update a message received via a network from an electronic device to shorten the message based on a comparison of the message to a stored dictionary; and
transmit the shortened version of the message via the network to the electronic device.

7. The apparatus of claim 6, wherein shortening the message comprises shortening the message based on a number of available characters.

8. The apparatus of claim 6, wherein the processor 302 further:
receives information about a recipient; and
compares the message to a stored dictionary associated with the recipient.

9. The apparatus of claim 6, wherein the processor 302 further:
receives feedback on the shortened version of the message; and
updates the stored dictionary based on the feedback.

10. The apparatus of claim 6, further comprising the electronic device, wherein the electronic device:
sends the message to the processor for shortening; and
receives the shortened version of the message from the processor via the network.

11. A machine-readable non-transitory storage medium 504 comprising instructions executable by a processor 503 to:
receive a message via a network from an electronic device;
determine to contract or expand the message;
contract the message based on a comparison of the message to a dictionary where determined to contract the message;
expand the message based on a comparison of the message to the dictionary where determined to expand the message; and
transmit the updated version of the message via the network to the electronic device.

12. The machine-readable non-transitory storage medium of claim 11 further comprising instructions to add terms to the dictionary based on automatic learning techniques.

13. The machine-readable non-transitory storage medium of claim 11, further comprising instructions to select a dictionary from a group of dictionaries for comparison to the message.

14. The machine-readable non-transitory storage medium of claim 11, where selecting a dictionary comprises selecting a dictionary based on at least one of: a recipient of the message or a dictionary identifier associated with the message.

15. The machine-readable non-transitory storage medium of claim 11, wherein instructions to contract the message comprise instructions to contract the message in a human readable format.
